(19) United States
(12) Patent Application Publication
(10) Pub. No.: US 2024/0312124 A1
(43) Pub. Date: Sep. 19, 2024

(54) GLOBAL ILLUMINATION REPRESENTATION METHOD IN AN INDOOR SCENE, DEVICE AND STORAGE MEDIUM

(71) Applicant: Realsee (Beijing) Technology Co., Ltd., Beijing (CN)

(72) Inventors: Zhen LI, Beijing (CN); Lingli WANG, Beijing (CN); Cihui PAN, Beijing (CN)

(21) Appl. No.: 18/601,156

(22) Filed: Mar. 11, 2024

(30) Foreign Application Priority Data
Mar. 16, 2023 (CN) 202310272053.8

(51) Int. Cl. G06T 15/50; G06T 5/60; G06T 5/70; G06T 7/40; G06T 15/04

(52) U.S. Cl. CPC G06T 15/506; G06T 5/60; G06T 5/70; G06T 7/40; G06T 15/04; G06T 2207/20084; G06T 2207/20208; G06T 2210/21

(57) ABSTRACT

A method for global illumination representation in an indoor scene is provided. The method includes: based on a high dynamic range (HDR) original image of a target scene and a three-dimensional space model of the target scene, determining texture index information of the three-dimensional space model; generating an HDR map of the three-dimensional space model based on the texture index information of the three-dimensional space model; sampling and integrating the HDR map in a hemispheric direction of any surface point in the three-dimensional space model to obtain a noise illuminance map of the three-dimensional space model; performing denoising processing on the noise illuminance map of the three-dimensional space model by using a pre-trained Monte-Carlo-denoising neural network to obtain a noise-free illuminance map of the three-dimensional space model; and storing the three-dimensional space model, the HDR map, and the noise-free illuminance map as a global illumination representation of the target scene.

### CROSS-REFERENCE TO RELATED APPLICATIONS

The application claims priority to Chinese Patent Application No. 202310272053.8, filed on Mar. 16, 2023, the content of which is hereby incorporated by reference in its entirety.

### FIELD

The present disclosure relates to the technical fields of computer vision and computer image processing, and in particular to a global illumination representation method in an indoor scene, and related device and storage medium.

### BACKGROUND

Global illumination representation of a real scene is of great significance to environmental illumination analysis and mixed reality. Obtaining the global illumination of the real scene may ensure that the virtual object has the same light and shadow performance as real environment. The global illumination representation of indoor scenes is often extremely complex. Due to the presence of a large number of occlusions and items of different materials, different places show completely different illumination. Therefore, obtaining a true global illumination representation is in need for obtaining the actual illumination of each location accurately.

In the existing technology, image-based illumination is used to represent the global illumination at a certain point in space, that is, a high dynamic range (HDR) panorama is used to represent illumination from each direction received at a certain point in space. Although an HDR panorama may retain all details and is directly equivalent to global illumination, an HDR panorama may only represent the global illumination at a certain spatial point. Therefore, a large number of HDR panoramas need to be stored to represent global illumination at any spatial point in a three-dimensional scene, which imposes high requirements on the storage space and memory of the device.

### SUMMARY

A technical problem to be solved by the embodiments of the present disclosure is to provide a global illumination representation method in an indoor scene, and related device and storage medium.

According to an aspect of an embodiment of the present disclosure, a global illumination representation method in an indoor scene is provided. The method includes:
based on a high dynamic range (HDR) original image of a target scene and a three-dimensional space model of the target scene, determining texture index information of the three-dimensional space model, where the texture index information is used to index HDR texture of the three-dimensional space model;
generating an HDR map of the three-dimensional space model based on the texture index information of the three-dimensional space model;
sampling and integrating the HDR map in a hemispheric direction of any surface point in the three-dimensional space model to obtain a noise illuminance map of the three-dimensional space model;
performing denoising processing on the noise illuminance map of the three-dimensional space model by using a pre-trained Monte-Carlo-denoising neural network to obtain a noise-free illuminance map of the three-dimensional space model; and
storing the three-dimensional space model, the HDR map, and the noise-free illuminance map as a global illumination representation of the target scene.

According to one embodiment of the present disclosure, the sampling and integrating the HDR map in the hemispheric direction of any surface point in the three-dimensional space model to obtain the noise illuminance map of the three-dimensional space model includes:
based on any pixel point of the HDR map, determining the spatial coordinates of the corresponding spatial point in the three-dimensional space model;
sampling and integrating, using the Monte-Carlo random sampling algorithm and the spatial coordinates of the corresponding spatial point, the HDR map in the hemispheric direction of the corresponding spatial point to obtain illuminance of the corresponding spatial point; and
based on the illuminance of any pixel point corresponding to the spatial point of the HDR map, generating a noise illuminance map of the three-dimensional spatial model.

According to yet another embodiment of the present disclosure, the sampling and integrating HDR map in the hemispherical direction of the corresponding spatial point to obtain the illuminance of the corresponding spatial point is implemented through Formula (1):

$${L}_{O} ( x , {w}_{o} ) = {\int }_{H +} Q ( x , {w}_{i} , G , {T}_{h d r} ) ( {w}_{i} \cdot n ) {dw}_{i} \qquad Formula ( 1 )$$

H+ represents the hemisphere direction, x represents coordinates of the spatial point for calculating illuminance, wᵢ represents the opposite direction of the incident light; n represents the normal vector of a spatial point; Q represents the HDR floating-point value queried from the HDR map, the query point is the intersection point between the three-dimensional spatial model and wᵢ.

In yet another embodiment of the present disclosure, the method further includes:
receiving an illuminance query instruction, where the illuminance query instruction carries position coordinates of the illuminance point to be queried; and
based on the position coordinates of the illuminance point to be queried, obtaining the illuminance of the illuminance point to be queried from the noise-free illuminance map.

In yet another embodiment of the present disclosure, the method further includes: receiving the illuminance query instruction, where the illuminance query instruction carries position coordinates of the illuminance point to be queried and the querying method;
using a light diffraction algorithm to obtain the intersection point of the illuminance point to be queried with the three-dimensional space model in the query direction; and
querying a HDR floating point value of the intersection point in the HDR map to obtain the HDR illumination of the illuminance point to be queried.

In yet another embodiment of the present disclosure, before the determining the texture index information of the three-dimensional space model, the method further includes:
on at least one collection point, collecting the HDR original image of the target scene;
converting the HDR original image of the target scene into an LDR original image; and
based on the LDR original image and the corresponding collection points, generating a three-dimensional spatial model of the target scene.

In yet another embodiment of the present disclosure, the texture index information of the three-dimensional space model includes: picture identification information of the input HDR original image corresponding to the texture of any surface point of the three-dimensional space model, and a HDR floating point value corresponding to the pixel point in the input HDR original image.

In yet another embodiment of the present disclosure, the generating the HDR map of the three-dimensional space model based on the texture index information of the three-dimensional space model includes:
based on the texture index information of the three-dimensional space model, indexing the input HDR original image corresponding to the texture of any surface point and the HDR floating point value of the corresponding pixel point in the input HDR original image; and
generating the HDR floating point values of the textures of all surface points of the three-dimensional space model as the HDR textures.

According to another aspect of the embodiment of the present disclosure, a global illumination device of in an indoor scene is provided, characterized in that the device includes:
a texture indexing module, configured to based on a HDR original image of a target scene and a three-dimensional space model of the target scene, determine texture index information of the three-dimensional space model, where the texture index information is used to index HDR texture of the three-dimensional space model;
a texture generating module, configured to generate an HDR map of the three-dimensional space model based on the texture index information of the three-dimensional space model;
a sampling and integrating module, configured to sample and integrate the HDR map in a hemispheric direction of any surface point in the three-dimensional space model to obtain a noise illuminance map of the three-dimensional space model;
a denoising module, configured to perform denoising processing on the noise illuminance map of the three-dimensional space model by using a pre-trained Monte-Carlo-denoising neural network to obtain a noise-free illuminance map of the three-dimensional space model; and
a storing module, configured to store the three-dimensional space model, the HDR map, and the noise-free illuminance map as a global illumination representation of the target scene.

In an embodiment of the present disclosure, the sampling and integrating module includes:
a coordinate determining submodule, configured to based on any pixel point of the HDR map, determine the spatial coordinates of the corresponding spatial point in the three-dimensional space model;
a sampling and integrating submodule, configured to use the Monte-Carlo random sampling algorithm and the spatial coordinates of the corresponding spatial point, to sample and integrate the HDR map in the hemispheric direction of the corresponding spatial point to obtain illuminance of the corresponding spatial point; and
an illuminance-map submodule, configured to based on the illuminance of any pixel point corresponding to the spatial point of the HDR map, generate a noise illuminance map of the three-dimensional spatial model.

In yet another embodiment of the present disclosure, the sampling and integrating submodule implements sampling and integration through Formula (1):

$${L}_{O} ( x , {w}_{o} ) = {\int }_{H +} Q ( x , {w}_{i} , G , {T}_{h d r} ) ( {w}_{i} \cdot n ) {dw}_{i} \qquad Formula ( 1 )$$

H+ represents the hemisphere direction, x represents coordinates of the spatial point for calculating illuminance, wᵢ represents the opposite direction of the incident light; n represents the normal vector of a spatial point; Q represents the HDR floating-point value queried from the HDR map, the query point is the intersection point between the three-dimensional spatial model and wᵢ.

In yet another embodiment of the present disclosure, the device further includes:
a first receiving module, configured to receive an illuminance query instruction, where the illuminance query instruction carries position coordinates of the illuminance point to be queried; and
an illuminance obtaining module, configured to based on the position coordinates of the illuminance point to be queried, obtain the illuminance of the illuminance point to be queried from the noise-free illuminance map.

In yet another embodiment of the present disclosure, the device further includes:
a second receiving module, configured to receive the illuminance query instruction, where the illuminance query instruction carries position coordinates of the illuminance point to be queried and the querying method;
an intersection-point obtaining module, configured to use a light diffraction algorithm to obtain the intersection point of the illuminance point to be queried with the three-dimensional space model in the query direction; and
an illuminance obtaining module, configured to query a HDR floating point value of the intersection point in the HDR map to obtain the HDR illumination of the illuminance point to be queried.

In yet another embodiment of the present disclosure, the device further includes:
an image collecting module, configured to on the at least one collection point, collect the HDR original image of the target scene;
a converting module, configured to convert the HDR original image of the target scene into an LDR original image; and
a model generating module, configured to based on the LDR original image and the corresponding collection points, generate a three-dimensional spatial model of the target scene.

In yet another embodiment of the present disclosure, the texture index information of the three-dimensional space model includes: picture identification information of the input HDR original image corresponding to the texture of any surface point of the three-dimensional space model, and a HDR floating point value corresponding to the pixel point in the input HDR original image.

In yet another embodiment of the present disclosure, the texture generating module includes:
an index submodule, configured to based on the texture index information of the three-dimensional space model, index the input HDR original image corresponding to the texture of any surface point and the HDR floating point value of the corresponding pixel point in the input HDR original image; and
a texture generating submodule, configured to generate the HDR floating point values of the textures of all surface points of the three-dimensional space model as the HDR textures.

According to yet another aspect of the embodiments of the present disclosure, an electronic device is provided, the electronic device includes:
a memory, configured to store computer programs; and
a processor, configured to execute a computer program stored in the memory, and when the computer program is executed, implement the above global illumination representation method in an indoor scene.

According to yet another aspect of an embodiment of the present disclosure, a computer-readable storage medium is provided, on which a computer program is stored. When the computer program is executed by a processor, the above-mentioned global illumination representation method in an indoor scene is implemented.

According to yet another aspect of an embodiment of the present disclosure, a computer program product is provided, including a computer program/instruction, when the computer program/instruction is executed by a processor, the above global illumination representation method in an indoor scene is implemented.

Based on the global illumination representation method in an indoor scene, device and storage medium according to the above embodiments of the present disclosure, when it is necessary to generate a global illumination representation for a target scene, based on multiple HDR original images and three-dimensional space models collected from the target scene, the texture index information of the three-dimensional space model is determined, and then the HDR map of the three-dimensional space model is generated based on the texture index information, by performing hemispheric sampling and integration on any surface point of the three-dimensional space model (the space point corresponding to any pixel point in the HDR map), the noise illuminance map of the three-dimensional space model may be obtained, and then the noise-free illuminance map may be obtained through the pre-trained denoising neural network. Thus, the three-dimensional space model, the corresponding HDR map. and the noise-free illuminance map may be stored as the global illumination representation of the target scene. The technical solution of the present disclosure implements a texture map-based illumination representation for the target scene based on HDR maps, illuminance maps and three-dimensional space models. Compared with the HDR-panorama-based illumination representation in the prior art, the present disclosure greatly improves the storage efficiency of the global illumination representation of the target scene, reduces the occupation of storage space, and effectively solves the problem of wasting storage resources caused by illumination representation based on HDR panorama.

The technical solution of the present disclosure will be described in further detail below through the accompanying drawings and examples.

### BRIEF DESCRIPTION OF THE DRAWINGS

The accompanying drawings, which constitute a part of the description, illustrate embodiments of the present disclosure and, together with the description, serve to explain principles of the present disclosure.

The present disclosure may be more clearly understood from the following detailed description with reference to the accompanying drawings.

FIG. 1 is a flowchart of one embodiment of a global illumination representation method in an indoor scene of the present disclosure.

FIG. 2A is a flowchart of one embodiment of precomputing a noise-free illuminance map of a three-dimensional spatial model of the present disclosure.

FIG. 2B is a schematic diagram of illuminance calculation for precomputing the noise-free illuminance map of the three-dimensional space model of the present disclosure.

FIG. 3A is a flowchart of querying the illuminance of a point in the global illumination representation method in an indoor scene of the present disclosure.

FIG. 3B is a flowchart of querying the illuminance of a point in one direction in the global illumination representation method in an indoor scene of the present disclosure.

FIG. 4 is a schematic structural diagram of an embodiment of a global illumination device in an indoor scene of the present disclosure.

FIG. 5 is a schematic structural diagram of another embodiment of a global illumination device in an indoor scene of the present disclosure.

FIG. 6 is a schematic structural diagram of another embodiment of a global illumination device in an indoor scene of the present disclosure.

FIG. 7 is a structural diagram of an electronic device according to an exemplary embodiment of the present disclosure.

### DESCRIPTION OF THE PREFERRED EMBODIMENTS

Various exemplary embodiments of the present disclosure will be described in detail with reference to the accompanying drawings. It should be noted that the relative arrangement of components and steps, numerical expressions, and numerical values set forth in these embodiments do not limit the scope of the disclosure unless otherwise specifically stated.

At the same time, it should be understood that, for the convenience of description, the dimensions of various parts shown in the drawings are not drawn based on actual proportional relationships.

The following description of at least one exemplary embodiment is merely illustrative in nature and is by no means intended to limit the disclosure, its application or uses.

Techniques, methods and devices known to those skilled in the art may not be discussed in detail. However, where appropriate, such techniques, methods and devices should be considered a part of the description.

It should be noted that similar reference numerals and letters refer to similar items in the following figures, so that once an item is defined in one figure, it does not require further discussion in subsequent figures.

Embodiments of the present disclosure may be applied to electronic devices such as computer systems/servers, which may operate with numerous other general purpose or special purpose computing system environments or configurations. Examples of well-known computing systems, environments and/or configurations suitable for use with electronic devices such as computer systems/servers include, but are not limited to: personal computer systems, server computer systems, thin clients, thick clients, handheld or laptop devices, microprocessor-based systems, set-top boxes, programmable consumer electronics, networked personal computers, small computer systems, mainframe computer systems, and distributed cloud computing technology environments including any of the above systems, among others.

Electronic devices such as computer systems/servers may be described in the general context of computer system executable instructions (such as program modules) being executed by the computer system. Generally, program modules may include routines, programs, object programs, components, logic, data structures, etc., that perform specific tasks or implement specific abstract data types. The computer system/server may be implemented in a distributed cloud computing environment. In the distributed cloud computing environment, tasks are performed by remote processing devices linked through a communications network. In a distributed cloud computing environment, program modules may be stored on local or remote computing system storage media including storage devices.

### EXEMPLARY EMBODIMENTS

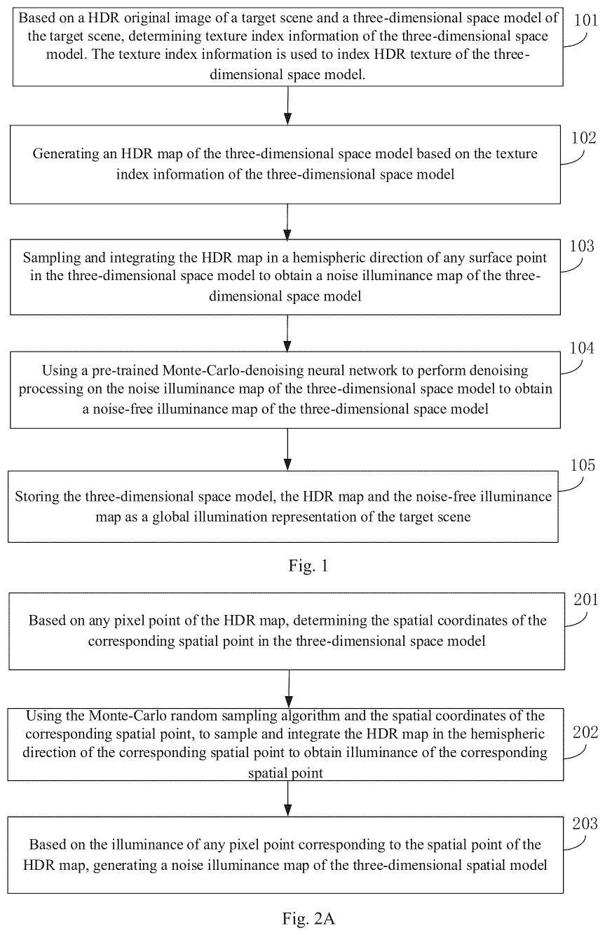

FIG. 1 is a flowchart of an embodiment of a global illumination representation method in an indoor scene of the present disclosure. The global illumination representation method in an indoor scene may be applied to electronic devices (such as computer systems, servers). As shown in FIG. 1, the global illumination representation method in indoor scenes includes the following steps.

In step 101, based on a high dynamic range (HDR) original image of a target scene and a three-dimensional space model of the target scene, determining texture index information of the three-dimensional space model. The texture index information is used to index HDR texture of the three-dimensional space model.

In an embodiment, multiple sets of HDR original images may be collected on at least one collection point through a HDR image collecting device, and then the HDR original images are converted into low dynamic range (LDR) images, and then based on the LDR original image and the corresponding collection points, a three-dimensional spatial model of the target scene is generated. In an exemplary implementation, existing model constructing algorithms may be used to construct a three-dimensional spatial model of the target scene.

In an embodiment, after the three-dimensional space model of the target scene is constructed, multi-perspective mapping may be performed on the target three-dimensional space based on the three-dimensional space model, the original HDR image, and the collection point of each image (including the collection position and collection posture). Furthermore, the texture index information of the three-dimensional space model is stored in the multi-perspective mapping stage. The texture index information may include the picture identification information of the input HDR original image corresponding to the texture of any surface point of the three-dimensional space model, and the HDR floating point value of the corresponding pixel point in the input HDR original image.

In this embodiment, any surface point of the three-dimensional space model refers to the point corresponding to all pixel points of the HDR map in the three-dimensional space model.

In step 102, generating an HDR map of the three-dimensional space model based on the texture index information of the three-dimensional space model.

In an embodiment, the generating the HDR map of the three-dimensional space model based on the texture index information of the three-dimensional space model includes: based on the texture index information of the three-dimensional space model, indexing the input HDR original image corresponding to the texture of any surface point and the HDR floating point value of the corresponding pixel point in the input HDR original image; and generating the HDR floating point values of the textures of all surface points of the three-dimensional space model as the HDR textures.

In an exemplary implementation, the texture index information may be queried to obtain the input HDR original image of any surface point of the three-dimensional space model, and the HDR floating point value of the pixel point corresponding to any surface point, so that the HDR floating point values of all surface points of the three-dimensional space model may be obtained, that is, the HDR map of the three-dimensional space model may be obtained.

In step 103, sampling and integrating the HDR map in a hemispheric direction of any surface point in the three-dimensional space model to obtain a noise illuminance map of the three-dimensional space model.

In an embodiment, the illuminance received by any surface point in the three-dimensional space model may be obtained by sampling and integrating the HDR map in the hemispheric direction of any surface point in the three-dimensional space model through a manner of pre-calculating the illuminance.

In an exemplary implementation, Formula (1) may be used to sample and integrate the HDR map in the hemispheric direction of any surface point in the three-dimensional space model to obtain the illuminance received by any surface point in the three-dimensional space model:

$${L}_{O} ( x , {w}_{o} ) = {\int }_{H +} Q ( x , {w}_{i} , G , {T}_{h d r} ) ( {w}_{i} \cdot n ) {dw}_{i} \qquad Formula ( 1 )$$

H+ represents the hemisphere direction, x represents coordinates of the spatial point for calculating illuminance, wᵢ represents the opposite direction of the incident light; n represents the normal vector of a spatial point; Q represents the HDR floating-point value queried from the HDR map, the query point is the intersection point between the three-dimensional spatial model and wᵢ.

In an embodiment, Formula (1) discloses an exemplary implementation method for calculating the noise illuminance map of a three-dimensional space model, and is an example of calculating the illuminance map through an HDR map. However, this embodiment does not limit the specific illuminance calculation formula. In addition to calculating the illuminance received by any surface point in the three-dimensional space model through Formula (1), the illuminance may be calculated by other illuminance calculation formulas based on the hemispheric direction.

In an embodiment, since it is necessary to perform sampling and integration on the hemispheric direction of any surface point in the three-dimensional space model when calculating illumination, in order to reduce the calculation amount of sampling and integration and improve the efficiency of sampling and integration, the present disclosure uses Monte-Carlo randomization sampling algorithm to calculate the illuminance of any surface point in the three-dimensional space model, which generates noise, so the illuminance map obtained is a noise illuminance map.

In step 104, performing denoising processing on the noise illuminance map of the three-dimensional space model by using a pre-trained Monte-Carlo-denoising neural network to obtain a noise-free illuminance map of the three-dimensional space model.

In an embodiment, in order to obtain a noise-free illuminance map, a pre-trained Monte-Carlo denoising neural network may be used to de-noise noisy low-sampling results, thereby quickly obtaining a noise-free image of the entire three-dimensional space model. The Monte-Carlo denoising neural network may use an existing denoising neural network, which is not described here.

In step 105, storing the three-dimensional space model, the HDR map, and the noise-free illuminance map as a global illumination representation of the target scene.

In an embodiment, after storing the three-dimensional space model, the HDR map, and the noise-free illuminance map as the global illumination representation of the target scene, in the shading and rendering stage, rendering techniques such as rasterization/ray casting may be used to efficiently obtain the global illumination received by any spatial point in the target three-dimensional space from any direction.

In an embodiment, storing the three-dimensional space model, HDR map, and noise-free illuminance map as global illumination representation does not require a large storage space. Compared to the Spherical-Gaussian (SG)-based illumination representation, which requires about 1 GB of storage space, and the Spherical-Harmonics (SH)-based illumination representation, which requires hundreds of megabytes of storage space, the global illumination representation of the present disclosure, combining the three-dimensional space model, the HDR map, and the noise-free illuminance map, may only occupy 20 to 30 megabytes of storage space. This greatly reduces the storage space, while the rendering effect can also maximize the preservation of the global illumination of the target scene.

In the above steps 101˜105, when it is necessary to generate a global illumination representation for a target scene, based on multiple HDR original images and three-dimensional space models collected from the target scene, the texture index information of the three-dimensional space model may be determined, and then the HDR map of the three-dimensional space model may be generated based on the texture index information, by performing hemispheric sampling and integration on any surface point of the three-dimensional space model (the space point corresponding to any pixel point in the HDR map), the noise illuminance map of the three-dimensional space model may be obtained, and then the noise-free illuminance map may be obtained through the pre-trained denoising neural network. Thus, the three-dimensional space model, the corresponding HDR map, and the noise-free illuminance map may be stored as the global illumination representation of the target scene. The present disclosure implements the global illumination representation of the target scene through a texture map-based illumination representation composed of an HDR map, an illuminance map, and a three-dimensional space model. Compared with the HDR-panorama-based illumination representation in the prior art, the present disclosure greatly improves the storage efficiency of the global illumination representation of the target scene, reduces the occupation of storage space, and effectively solves the problem of wasting storage resources caused by illumination representation based on HDR panorama.

In order to better illustrate the global illumination solution in indoor scenes of the present disclosure, another embodiment will be used to illustrate below.

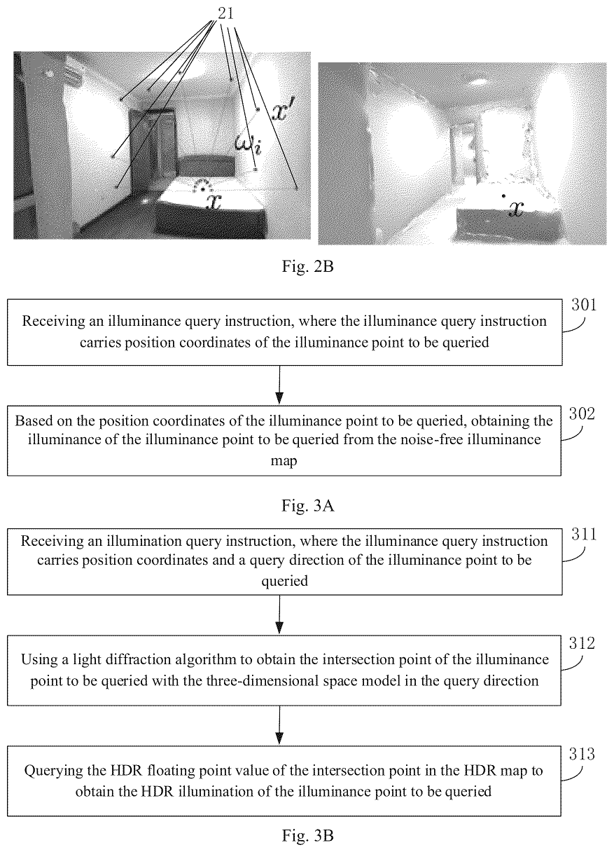

FIG. 2A is a flowchart of one embodiment of precomputing a noise-free illuminance map of the three-dimensional space model of the present disclosure. FIG. 2B is a schematic diagram of illumination calculation for precomputing the noise-free illuminance map of the three-dimensional space model of the present disclosure. According to this embodiment, an exemplary explanation of the method of pre-calculating noise illuminance is provided, as shown in FIG. 2A, the method includes following steps.

In step 201, based on any pixel point of the HDR map, determining the spatial coordinates of the corresponding spatial point in the three-dimensional space model.

In an embodiment, when the three-dimensional space model is mapped in the multi-perspective mapping stage, the mapping relationship between any pixel point of the HDR map of the three-dimensional model space and the spatial point of the three-dimensional model space is stored. Therefore, based on any pixel point of the HDR map, the spatial coordinates of the corresponding spatial point in the three-dimensional space model are determined.

In step 202, using the Monte-Carlo random sampling algorithm and the spatial coordinates of the corresponding spatial point, to sample and integrate the HDR map in the hemispheric direction of the corresponding spatial point to obtain illuminance of the corresponding spatial point.

Referring to FIG. 2B, the left side of FIG. 2B illustrates the illuminance sampling calculation diagram of point x, which is obtained by calculating all HDR illuminance values in the hemispheric direction corresponding to its normal vector (the illuminance values emitted by the points indicated by Reference Sign 21 in FIG. 2B), all HDR illumination values in the hemispheric direction corresponding to its normal vector may be obtained through Monte Carlo random sampling. After sampling all HDR illumination values in the hemispheric direction corresponding to its normal vector, the illuminance received by point x may be calculated using Formula (1) in the embodiment shown in FIG. 1.

In an embodiment, Formula (1) discloses a calculation manner of the noise illuminance map of the three-dimensional space model. The calculated illuminance result of the three-dimensional model space is shown in the right side of FIG. 2B, in which the illuminance in a direction facing the light source is the highest, and due to occlusion, the illumination at the foot of the bed is lower.

In step 203, based on the illuminance of any pixel point corresponding to the spatial point of the HDR map, generating a noise illuminance map of the three-dimensional spatial model.

In an embodiment, when the illuminance of any surface point in the three-dimensional model space is calculated, it is necessary to sample and integrate HDR illuminance values in all hemispheric directions, while the Monte Carlo random sampling manner will cause noise. In order to obtain a noise-free illuminance map, a pre-trained Monte-Carlo-denoising neural network may be used to denoise noisy low-sampling results, and then the entire noise-free illuminance map is quickly obtained. The noise-free illuminance map stores the position coordinates of each point in the three-dimensional model space and the illumination corresponding to that point.

Through the above steps 201˜203, the illuminance map of the entire target scene may be obtained by calculating the illuminance of any surface point in the three-dimensional model space (the space point corresponding to any pixel point in the HDR map). Moreover, combining Monte-Carlo-random sampling algorithm and Monte-Carlo-denoising neural network may greatly reduce the amount of sampling data and calculations and improve the efficiency of illumination calculations while ensuring a noise-free illuminance map.

FIG. 3A is a flowchart of querying the illuminance of a point in the global illumination representation method in an indoor scene of the present disclosure. FIG. 3B is a flowchart of querying the illumination of a point in one direction in the global illumination representation method in an indoor scene of the present disclosure. According to this embodiment, a method of querying the illuminance of a point or the illumination of a point in one direction based on the global illumination representation in an indoor scene. As shown in FIG. 3A, an embodiment of obtaining the illuminance of a point when an illuminance query instruction is received includes the following steps.

In step 301, receiving an illuminance query instruction, where the illuminance query instruction carries position coordinates of the illuminance point to be queried.

In an embodiment, when the user needs to query the illuminance of a point, the illuminance query operation may be triggered by clicking, dragging, etc., so that the device can receive the illuminance query instruction corresponding to the illumination query operation, and the illuminance query instruction carries the position coordinates of the illuminance point to be queried.

In step 302, based on the position coordinates of the illuminance point to be queried, obtaining the illuminance of the illuminance point to be queried from the noise-free illuminance map.

In an embodiment, since the global illumination representation including the noise-free illuminance map has been previously stored, the illuminance of the illuminance point to be queried can be obtained in the noise-free illuminance map based on the position coordinates of the illuminance point to be queried.

As shown in FIG. 3B, an embodiment of obtaining the illumination of a point in a certain direction when an illuminance query instruction is received includes the following steps.

In step 311, receiving an illumination query instruction, where the illuminance query instruction carries position coordinates and a query direction of the illuminance point to be queried.

In an embodiment, when the user needs to query the illumination of a point in a certain direction, the illumination query operation may be triggered by clicking, dragging, etc., so that the device can receive the illumination corresponding to the illumination query operation. The illumination query instruction carries the position coordinates and the query direction of the illuminance point to be queried.

In step 312, using a light diffraction algorithm to obtain the intersection point of the illuminance point to be queried with the three-dimensional space model in the query direction.

In an embodiment, the intersection point (the position coordinates of the intersection point) of the illumination point to be queried with the three-dimensional space model in the query direction may be obtained through light diffraction (ray projection) technology.

In step 313, querying the HDR floating point value of the intersection point in the HDR map to obtain the HDR illumination of the illuminance point to be queried.

In an embodiment, based on the position table of the intersection, the pixel point of the corresponding HDR map may be queried. The illumination information recorded in the HDR floating point value of the pixel point is the HDR illumination received by the intersection point in the query direction.

Through the above steps 301˜302 and steps 311˜313, the global illumination representation based on the three-dimensional space model, the HDR map, and the illuminance map is realized quickly, and the illuminance of a point may be quickly queried, and the HDR illumination received by a point in the query direction, so the global illumination representation according to this embodiment can quickly obtain the global illumination of a point in any direction, and has small storage space, effectively solving the problem of wasting storage resources caused by illumination representation based on HDR panorama.

Corresponding to the above-mentioned embodiments of the global illumination representation method in an indoor scene, according to the present disclosure, an embodiment corresponding to a global illumination device in an indoor scene is provided.

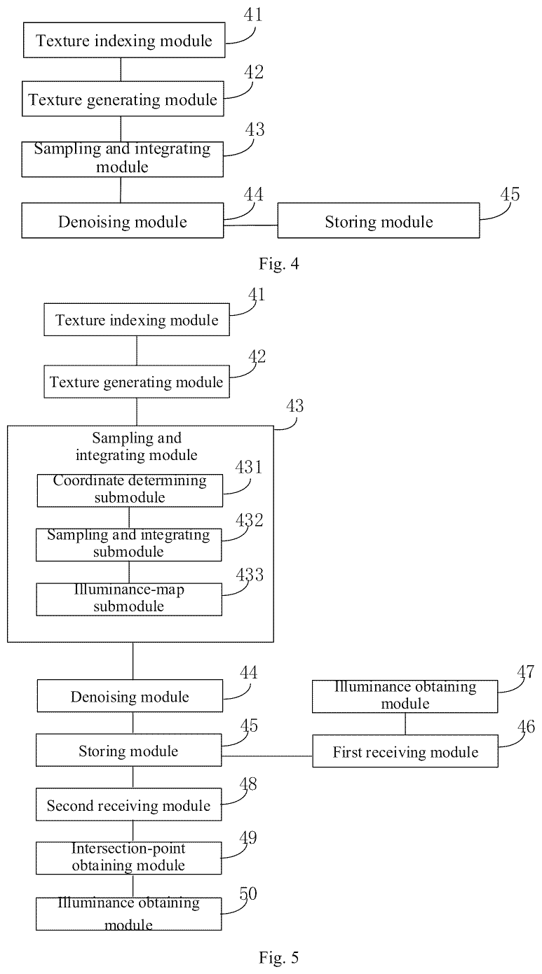

FIG. 4 is a schematic structural diagram of an embodiment of a global illumination device in an indoor scene of the present disclosure. The device is applied to electronic device (such as computer systems and servers). As shown in FIG. 4, the device includes:
a texture indexing module 41, configured to determine, based on a HDR original image of a target scene and a three-dimensional space model of the target scene, texture index information of the three-dimensional space model, where the texture index information is used to index HDR texture of the three-dimensional space model;
a texture generating module 42, configured to generate an HDR map of the three-dimensional space model based on the texture index information of the three-dimensional space model;
a sampling and integrating module 43, configured to sample and integrate the HDR map in a hemispheric direction of any surface point in the three-dimensional space model to obtain a noise illuminance map of the three-dimensional space model;
a denoising module 44, configured to perform denoising processing on the noise illuminance map of the three-dimensional space model by using a pre-trained Monte-Carlo-denoising neural network to obtain a noise-free illuminance map of the three-dimensional space model; and
a storing module 45, configured to store the three-dimensional space model, the HDR map, and the noise-free illuminance map as a global illumination representation of the target scene.

FIG. 5 is a schematic structural diagram of another embodiment of a global illumination device in an indoor scene of the present disclosure. As shown in FIG. 5, based on the embodiment shown in FIG. 4, in an embodiment, the sampling and integrating module 43 includes:
a coordinate determining submodule 431, configured to determine, based on any pixel point of the HDR map, the spatial coordinates of the corresponding spatial point in the three-dimensional space model;
a sampling and integrating submodule 432, configured to use the Monte-Carlo random sampling algorithm and the spatial coordinates of the corresponding spatial point, to sample and integrate the HDR map in the hemispheric direction of the corresponding spatial point to obtain illuminance of the corresponding spatial point; and
an illuminance-map submodule 433, configured to generate, based on the illuminance of any pixel point corresponding to the spatial point of the HDR map, a noise illuminance map of the three-dimensional spatial model.

In an embodiment, the sampling and integrating submodule implements sampling and integration through Formula (1):

$${L}_{O} ( x , {w}_{o} ) = {\int }_{H +} Q ( x , {w}_{i} , G , {T}_{h d r} ) ( {w}_{i} \cdot n ) {dw}_{i} \qquad Formula ( 1 )$$

H+ represents the hemisphere direction, x represents coordinates of the spatial point for calculating illuminance, wᵢ represents the opposite direction of the incident light; n represents the normal vector of a spatial point; Q represents the HDR floating-point value queried from the HDR map, the query point is the intersection point between the three-dimensional spatial model and wᵢ.

In an embodiment, the device further includes:
a first receiving module 46, configured to receive an illuminance query instruction, where the illuminance query instruction carries position coordinates of the illuminance point to be queried; and
an illuminance obtaining module 47, configured to obtain, based on the position coordinates of the illuminance point to be queried, the illuminance of the illuminance point to be queried from the noise-free illuminance map.

In an embodiment, the device further includes:
a second receiving module 48, configured to receive the illuminance query instruction, where the illuminance query instruction carries position coordinates of the illuminance point to be queried and the querying method;
an intersection-point obtaining module 49, configured to use a light diffraction algorithm to obtain the intersection point of the illuminance point to be queried with the three-dimensional space model in the query direction; and
an illuminance obtaining module 50, configured to query a HDR floating point value of the intersection point in the HDR map to obtain the HDR illumination of the illuminance point to be queried.

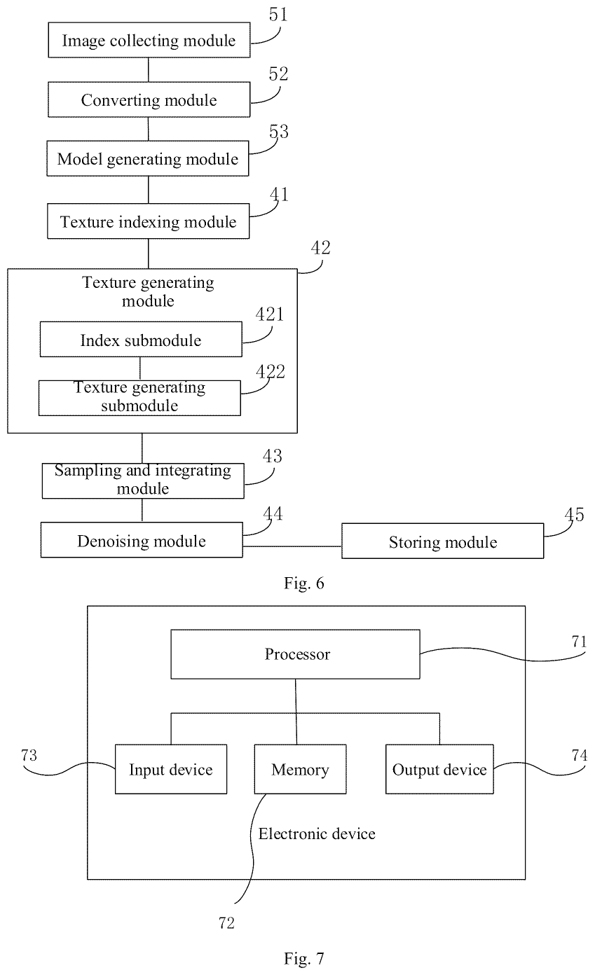

FIG. 6 is a schematic structural diagram of another embodiment of a global illumination device in an indoor scene of the present disclosure. As shown in FIG. 6, based on the embodiment shown in FIG. 4 and/or FIG. 5, in an embodiment, the device further includes:
an image collecting module 51, configured to collect, on the at least one collection point, the HDR original image of the target scene;
a converting module 52, configured to convert the HDR original image of the target scene into an LDR original image; and
a model generating module 53, configured to generate, based on the LDR original image and the corresponding collection points, a three-dimensional spatial model of the target scene.

In an embodiment, the texture index information of the three-dimensional space model includes: picture identification information of the input HDR original image corresponding to the texture of any surface point of the three-dimensional space model, and a HDR floating point value corresponding to the pixel point in the input HDR original image.

In an embodiment, the texture generation module 42 includes:
an index submodule 421, configured to index, based on the texture index information of the three-dimensional space model, the input HDR original image corresponding to the texture of any surface point and the HDR floating point value of the corresponding pixel point in the input HDR original image; and
a texture generating submodule 422, configured to generate the HDR floating point values of the textures of all surface points of the three-dimensional space model as the HDR textures.

Referring to the implementation process of the corresponding steps in the above method for details, the implementation process of the functions and effects of each unit in the above device will not be described again here.

As for the device embodiment, since it basically corresponds to the method embodiment, reference is made to the partial description of the method embodiment for relevant details. The device embodiments described above are only illustrative. The units described as separate components may or may not be physically separated. The components shown as units may or may not be physical units, that is, they may be located in one place, or it may be distributed to multiple network units. Some or all of the modules may be selected according to actual needs to achieve the purpose of the disclosed solution. Those skilled in the art can understand and implement the method without any creative effort.

Hereinafter, an electronic device according to an embodiment of the present disclosure is described with reference to FIG. 7, in which the device for implementing the method of the embodiment of the present disclosure may be integrated. FIG. 7 is a structural diagram of an electronic device according to an exemplary embodiment of the present disclosure. As shown in FIG. 7, the electronic device 7 includes one or more processors 71, one or more memories 72 of computer-readable storage media, and a computer program stored in memory and executable on a processor. When the program in the memory 72 is executed, the above-mentioned global illumination representation method in an indoor scene may be implemented.

Specifically, in practical applications, the electronic device may further include components such as an input device 73 and an output device 74. These components are interconnected through a bus system and/or other forms of connection mechanisms (not shown). Those skilled in the art can understand that the structure of the electronic device shown in FIG. 7 does not constitute a limitation of the electronic device, and may include more or fewer components than shown in the figure, or certain components, or different component arrangements.

The processor 71 may be a central processing unit (CPU) or other form of processing unit with data processing capabilities and/or instruction execution capabilities, by running or executing software programs and/or modules stored in the memory 72, and calling data stored in the memory 72. The data in the memory 72 performs various functions and processes data, thereby overall monitoring of the electronic device.

The memory 72 may include one or more computer program products, and the computer program products may include various forms of computer-readable storage media, such as volatile memory and/or non-volatile memory. Volatile memory may include, for example, random access memory (RAM) and/or cache memory (cache), etc. Non-volatile memory may include, for example, read-only memory (ROM), hard disk, flash memory, etc. One or more computer program instructions may be stored on a computer-readable storage medium, and the processor 71 may execute the program instructions to implement the above global illumination representation method in an indoor scene according to various embodiments of the present disclosure and/or other desired functions. Various contents such as input signals, signal components, noise components, etc. may also be stored in the computer-readable storage medium.

The input device 73 may be used to receive inputted numeric or character information, and to generate keyboard, mouse, joystick, optical or trackball signal inputs related to user settings and function control.

The output device 74 may output various information to the outside, including determined distance information, direction information, etc. The output device 74 may include, for example, a display, a speaker, a printer, a communication network and remote output devices connected thereto, and the like.

The electronic device may further include a power supply that supplies power to various components, and may be logically connected to the processor 71 through a power management system, thereby achieving functions such as management of charging, discharging, and power consumption management through the power management system. The power supply may further include one or more DC or AC power supplies, recharging systems, power failure detection circuits, power converters or inverters, power status indicators, and any other components.

Of course, for simplicity, only some of the components related to the present disclosure in the electronic device 7 are shown in FIG. 7, and components such as buses, input/output interfaces, etc. are omitted. In addition to this, the electronic device 7 may further include any other suitable components depending on the specific application.

In addition to the above methods and devices, embodiments of the present disclosure may also be a computer program product, which includes computer program instructions that, when executed by a processor, cause the processor to execute the steps in the global illumination representation method in an indoor scene according to various embodiments of the present described in the above-mentioned “exemplary method” in this description.

The computer program product may be written with program code for performing operations of embodiments of the present disclosure in any combination of one or more programming languages, including object-oriented programming languages such as Java, C++, etc., further includes conventional procedural programming languages, such as the “C” language or similar programming languages. The program code may execute entirely on a computing device of a user, partly on a device of a user, as a stand-alone software package, partly on the computing device of a user and partly on a remote computing device, or entirely on the remote computing device or server execute on.

In addition, embodiments of the present disclosure may also be a computer-readable storage medium having computer program instructions stored thereon. The computer program instructions, when executed by a processor, cause the processor to execute the steps in the global illumination representation method in an indoor scene according to various embodiments of the present disclosure described in the above-mentioned “example method” of this description.

The computer-readable storage medium may be any combination of one or more readable media. The readable medium may be a readable signal medium or a readable storage medium. The readable storage medium may include, for example, but is not limited to, electrical, magnetic, optical, electromagnetic, infrared, or semiconductor systems, devices or components, or any combination thereof. More specific examples (non-exhaustive list) of readable storage media include: electrical connection with one or more conductors, portable disk, hard disk, random access memory (RAM), read only memory (ROM), erasable programmable read-only memory (EPROM or flash memory), optical fiber, portable compact disk read-only memory (CD-ROM), optical storage device, magnetic storage device, or any suitable combination of the above.

The basic principles of the present disclosure have been described above in conjunction with exemplary embodiments. However, it should be noted that the advantages, strength, effects, etc. mentioned in the present disclosure are only examples and not limitations. It cannot be assumed that these advantages, strengths, effects, etc. are mandatory for all embodiments of the present disclosure. In addition, the specific details disclosed above are only for the purpose of illustration and to facilitate understanding, and not limiting. The above details do not limit the present disclosure to be implemented by using the above specific details.

Each embodiment in this description is described in a progressive manner, and each embodiment focuses on its differences from other embodiments. The same or similar parts between the various embodiments may be referred to each other. For the system embodiment, since it basically corresponds to the method embodiment, the description is relatively simple. For relevant details, reference is made to the partial description of the method embodiment.

Those skilled in the art can understand that all or part of the steps to implement the above method embodiments may be completed by hardware related to program instructions. The above-mentioned program may be stored in a computer-readable storage medium. When the program is executed, the program includes the steps of the above method embodiment; and the above-mentioned storage medium includes: ROM, RAM, magnetic disk or optical disk and other various media that can store program codes.

The methods and device of the present disclosure may be implemented in many manners. For example, the methods and devices of the present disclosure may be implemented through software, hardware, firmware, or any combination of software, hardware, and firmware. The above order for the steps of the methods is for illustration only, and the steps of the methods of the present disclosure are not limited to the order specifically described above unless otherwise specifically stated. Furthermore, in some embodiments, the present disclosure may also be implemented as programs recorded in recording media, and these programs include machine-readable instructions for implementing methods according to the present disclosure. Thus, the present disclosure also covers recording media storing programs for executing methods according to the present disclosure.

The description of the present disclosure has been presented for the purposes of illustration and description, and is not intended to be exhaustive or to limit the present disclosure to the form disclosed. Many modifications and variations will be apparent to those skilled in the art. Choosing and describing the embodiment is to better explain the principles of the disclosure and the practical application, and enables those skilled in the art to understand the present disclosure and design various embodiments with various modifications as are suited to the particular use contemplated.

What is claimed is:

1. A method for global illumination representation in an indoor scene, comprising:
determining, based on a high dynamic range (HDR) original image of a target scene and a three-dimensional space model of the target scene, texture index information of the three-dimensional space model, wherein the texture index information is used to index HDR texture of the three-dimensional space model;
generating an HDR map of the three-dimensional space model based on the texture index information of the three-dimensional space model;
sampling and integrating the HDR map in a hemispheric direction of any surface point in the three-dimensional space model to obtain a noise illuminance map of the three-dimensional space model;
performing denoising processing on the noise illuminance map of the three-dimensional space model by using a pre-trained Monte-Carlo-denoising neural network to obtain a noise-free illuminance map of the three-dimensional space model; and
storing the three-dimensional space model, the HDR map, and the noise-free illuminance map as a global illumination representation of the target scene.

2. The method of claim 1, wherein sampling and integrating the HDR map in the hemispheric direction of any surface point in the three-dimensional space model to obtain the noise illuminance map of the three-dimensional space model comprises:
determining, based on any pixel point of the HDR map, the spatial coordinates of the corresponding spatial point in the three-dimensional space model;
sampling and integrating, using a Monte-Carlo random sampling algorithm and the spatial coordinates of the corresponding spatial point, the HDR map in the hemispheric direction of the corresponding spatial point to obtain illuminance of the corresponding spatial point; and
generating, based on the illuminance of any pixel point corresponding to the spatial point of the HDR map, a noise illuminance map of the three-dimensional space model.

3. The method of claim 2, wherein sampling and integrating the HDR map in the hemispherical direction of the corresponding spatial point to obtain the illuminance of the corresponding spatial point is implemented through Formula (1):
$${L}_{O} ( x , {w}_{o} ) = {\int }_{H +} Q ( x , {w}_{i} , G , {T}_{h d r} ) ( {w}_{i} \cdot n ) {dw}_{i} \qquad Formula ( 1 )$$
wherein H+ represents the hemisphere direction, x represents coordinates of the spatial point for calculating the respective illuminance, wᵢ represents the opposite direction of incident light; n represents the normal vector of a spatial point; Q represents the HDR floating-point value queried from the HDR map, the query point is an intersection point between the three-dimensional space model and wᵢ.

4. The method of claim 1, further comprising:
receiving an illuminance query instruction, wherein the illuminance query instruction carries position coordinates of the illuminance point to be queried; and
obtaining, based on the position coordinates of the illuminance point to be queried, the illuminance of the illuminance point to be queried from the noise-free illuminance map.

5. The method of claim 1, further comprising:
receiving an illuminance query instruction, wherein the illuminance query instruction carries position coordinates of the illuminance point to be queried and the querying method;
obtaining, using a light diffraction algorithm, an intersection point of the illuminance point to be queried with the three-dimensional space model in the query direction; and
querying a HDR floating point value of the intersection point in the HDR map to obtain the HDR illumination of the illuminance point to be queried.

6. The method of claim 1, before the determining the texture index information of the three-dimensional space model, the method further comprising:
on at least one collection point, collecting the HDR original image of the target scene;
converting the HDR original image of the target scene into a low dynamic range (LDR) original image; and
based on the LDR original image and the corresponding at least one collection point, generating the three-dimensional space model of the target scene.

7. The method of claim 1, wherein the texture index information of the three-dimensional space model comprises:
picture identification information of the input HDR original image corresponding to the texture of any surface point of the three-dimensional space model; and
a HDR floating point value corresponding to any pixel point in the input HDR original image.

8. The method of claim 1, wherein generating the HDR map of the three-dimensional space model based on the texture index information of the three-dimensional space model comprises:
based on the texture index information of the three-dimensional space model, indexing the input HDR original image corresponding to the texture of any surface point and the HDR floating point value of the corresponding pixel point in the input HDR original image; and
generating the HDR floating point values of the textures of all surface points of the three-dimensional space model as the HDR textures.

9. A device for global illumination in an indoor scene, comprising:
a texture indexing module, configured to determine, based on a HDR original image of a target scene and a three-dimensional space model of the target scene, texture index information of the three-dimensional space model, wherein the texture index information is used to index HDR texture of the three-dimensional space model;
a texture generating module, configured to generate an HDR map of the three-dimensional space model based on the texture index information of the three-dimensional space model;
a sampling and integrating module, configured to sample and integrate the HDR map in a hemispheric direction of any surface point in the three-dimensional space model to obtain a noise illuminance map of the three-dimensional space model;
a denoising module, configured to perform denoising processing on the noise illuminance map of the three-dimensional space model by using a pre-trained Monte-Carlo-denoising neural network to obtain a noise-free illuminance map of the three-dimensional space model; and
a storing module, configured to store the three-dimensional space model, the HDR map, and the noise-free illuminance map as a global illumination representation of the target scene.

10. An electronic device, comprising:
a memory, configured to store computer programs; and
a processor, configured to execute a computer program stored in the memory, and when the computer program is executed, perform:
determining, based on a high dynamic range (HDR) original image of a target scene and a three-dimensional space model of the target scene, texture index information of the three-dimensional space model, wherein the texture index information is used to index HDR texture of the three-dimensional space model;
generating an HDR map of the three-dimensional space model based on the texture index information of the three-dimensional space model;
sampling and integrating the HDR map in a hemispheric direction of any surface point in the three-dimensional space model to obtain a noise illuminance map of the three-dimensional space model;
performing denoising processing on the noise illuminance map of the three-dimensional space model by using a pre-trained Monte-Carlo-denoising neural network to obtain a noise-free illuminance map of the three-dimensional space model; and
storing the three-dimensional space model, the HDR map, and the noise-free illuminance map as a global illumination representation of the target scene.

11. The electronic device of claim 10, wherein sampling and integrating the HDR map in the hemispheric direction of any surface point in the three-dimensional space model to obtain the noise illuminance map of the three-dimensional space model comprises:
determining, based on any pixel point of the HDR map, the spatial coordinates of the corresponding spatial point in the three-dimensional space model;
sampling and integrating, using a Monte-Carlo random sampling algorithm and the spatial coordinates of the corresponding spatial point, the HDR map in the hemispheric direction of the corresponding spatial point to obtain illuminance of the corresponding spatial point; and
generating, based on the illuminance of any pixel point corresponding to the spatial point of the HDR map, a noise illuminance map of the three-dimensional space model.

12. The electronic device of claim 11, wherein sampling and integrating the HDR map in the hemispherical direction of the corresponding spatial point to obtain the illuminance of the corresponding spatial point is implemented through Formula (1):
$${L}_{O} ( x , {w}_{o} ) = {\int }_{H +} Q ( x , {w}_{i} , G , {T}_{h d r} ) ( {w}_{i} \cdot n ) {dw}_{i} \qquad Formula ( 1 )$$
wherein H+ represents the hemisphere direction, x represents coordinates of the spatial point for calculating the respective illuminance, wᵢ represents the opposite direction of incident light; n represents the normal vector of a spatial point; Q represents the HDR floating-point value queried from the HDR map, the query point is an intersection point between the three-dimensional space model and wᵢ.

13. The electronic device of claim 10, wherein the processor is further configured to perform:
receiving an illuminance query instruction, wherein the illuminance query instruction carries position coordinates of the illuminance point to be queried; and
obtaining, based on the position coordinates of the illuminance point to be queried, the illuminance of the illuminance point to be queried from the noise-free illuminance map.

14. The electronic device of claim 10, wherein the processor is further configured to perform:
receiving an illuminance query instruction, wherein the illuminance query instruction carries position coordinates of the illuminance point to be queried and the querying method;
obtaining, using a light diffraction algorithm, an intersection point of the illuminance point to be queried with the three-dimensional space model in the query direction; and
querying a HDR floating point value of the intersection point in the HDR map to obtain the HDR illumination of the illuminance point to be queried.

15. The electronic device of claim 10, wherein before the determining the texture index information of the three-dimensional space model, the processor is further configured to perform:
on at least one collection point, collecting the HDR original image of the target scene;
converting the HDR original image of the target scene into a low dynamic range (LDR) original image; and
based on the LDR original image and the corresponding at least one collection point, generating the three-dimensional space model of the target scene.

16. The electronic device of claim 10, wherein the texture index information of the three-dimensional space model comprises:
picture identification information of the input HDR original image corresponding to the texture of any surface point of the three-dimensional space model; and
a HDR floating point value corresponding to any pixel point in the input HDR original image.

17. The electronic device of claim 10, wherein generating the HDR map of the three-dimensional space model based on the texture index information of the three-dimensional space model comprises:
based on the texture index information of the three-dimensional space model, indexing the input HDR original image corresponding to the texture of any surface point and the HDR floating point value of the corresponding pixel point in the input HDR original image; and
generating the HDR floating point values of the textures of all surface points of the three-dimensional space model as the HDR textures.
